(19) United States
(12) Patent Application Publication
(10) Pub. No.: US 2008/0109224 A1
(43) Pub. Date: May 8, 2008

(54) AUTOMATICALLY PROVIDING AN INDICATION TO A SPEAKER WHEN THAT SPEAKER'S RATE OF SPEECH IS LIKELY TO BE GREATER THAN A RATE THAT A LISTENER IS ABLE TO COMPREHEND

(75) Inventors: JOSEPH L. DVORAK, BOCA RATON, FL (US); NONA E. GAGE, SEA RANCH LAKES, FL (US); JOSE E. KORNELUK, LAKE WORTH, FL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/555,792

(22) Filed: Nov. 2, 2006

(51) Int. Cl. G10L 15/04

(52) U.S. Cl. 704/251; 704/E15.001

(57) ABSTRACT

The present invention discloses a solution that automatically informs a speaker to decrease his or her speaking rate, when that rate likely exceeds a rate that a listener can understand. This can be accomplished by determining a speaking rate for the speaker, which is compared against a speaking rate threshold. The speaking rate threshold can be based upon a listening rate, estimated or known, of the listener. The listening rate can be a variable value based in part upon a proficiency that the listener has with a language being spoken. The speaker can be informed to slow down by an activation of a sensory mechanism of a wearable computing device designed to vibrate, beep, blink, speak a message, display a message, and the like, whenever a speaking rate of the speaker exceeds the speaking rate threshold.

### BACKGROUND

1. Field of the Invention

the present invention relates to automated speech technologies and, more particularly, to automatically providing an indication to a speaker when that speaker's rate of speech is likely to be greater than a rate that a listener is able to comprehend

2. Description of the Related Art

Understanding a person speaking their native language can be difficult when that language is not a primary language of a listener since the native speaker often speaks too rapidly for the listener to digest the spoken words. For example, a person from Japan, who is moderately proficient in English, can have trouble understanding a native English speaking person, who is speaking at a pace that would be typically used when talking to another native English speaker.

One simple solution to improve understanding is for a speaker to slow down their speaking rate when speaking to a non-native speaker. Unfortunately, a speaker often fails to recognize the listener's difficulty in understanding a conversation and fails to decrease their speaking rate. The non-native listener is often embarrassed or reticent to ask the speaker to slow down. This can be especially true if the listener has already asked the speaker to slow down once or twice during a conversation, which the speaker has done only to inadvertently increase his or her speaking rate as the conversation endures or as the emotional pitch of the conversation escalates.

Acoustic an semantic clarity of a speaker is also a factor for determining a speaking rate, which a listener can comprehend. For example, when a speaker uses colloquialisms, which can be very difficult for a non-native speaker to process, a speaking rate should be even slower than normal. In another example, strong accents and/or dialects can increase listener difficulty, even when a listener is a native speaker of the language being spoken. This increased listener difficulty can be compensated for by a corresponding speaking rate decrease. Additionally, when a speaker mumbles or has speech idiosyncrasies, he or she can be harder than normal to understand, unless the speaking ate of the speaker is decreased to a slower than normal rate. In still another example, a clarity problem can occur for communications over a voice network connection due to the quality of the voice network being low or inconsistent. As a result, the speech received by a listener can be difficult to comprehend. Network clarity problems can be compensated for by having a speaker decrease their rate of speech. No known device or solution exists that detects situations in which a speaking rate is too rapid for a listener and that automatically informs a speaker to reduce his or her speaking rate accordingly.

### SUMMARY OF THE INVENTION

The present invention discloses a solution that automatically informs a speaker to decrease his or her speaking rate, when that rate likely exceeds a rate that a listener can understand. This can be accomplished by determining a speaking rate for the speaker, which is compared against a speaking rate threshold. The speaking rate threshold can be based upon a listening rate, estimated or known, of the listener. The listening rate can be a variable value based in part upon a proficiency that the listener has with a language being spoken. The speaker can be informed to slow down by an activation of a sensory mechanism of a wearable computing device that is designed to vibrate, beep, blink, speak a message, display a message, and the like, whenever a speaking rate of the speaker exceeds the speaking rate threshold.

The present invention can be implemented in accordance with numerous aspects consistent with the material presented herein. For example, one aspect of the present invention can include an automated method to facilitate understanding between discourse participants. The method can include a step of automatically ascertaining a speaking rate threshold for a listener. The speaking rate threshold can be a threshold over which the listener is likely to have difficulty comprehending speech. A speaking rate of a speaker can then be automatically determined. The speaker can be automatically notified that his or her speaking rate should be decreased, whenever the speaking rate exceeds the speaking rate threshold.

Another aspect of the present invention can include a method for facilitating comprehension during a discourse bed in part upon a discourse language. The method can begin in a situation wherein a speaker is engaged in a discourse with a listener. A language of the discourse can be determined. A listener's proficiency with the language can be ascertained and used to establish a speaking rate threshold. A speaking rate of the speaker can then be determined. When the speaking rate exceeds the speaking rate threshold, the speaker can be automatically notified to decrease his or her speaking rate.

Yet another aspect of the present invention can include a device for facilitating understanding between discourse participants that includes a microphone and a sensory mechanism. The microphone can receive speech of a speaker. The sensory mechanism can automatically inform the speaker when tat speaker's rate of speech is too rapid for a listener to easily comprehend spoken dialog. The determination that the speaking rate is too rapid can be based upon automatically comparing the speaking rate of the speaker against a previously established speaking rate threshold.

In one embodiment, the device can also include a speaking rate processor and a comprehension comparator. The speaking rate processor can determine the speaking rate for speech, which is obtained via the microphone. The comprehension comparator can compare the determined speaking rate against the speaking rate threshold. In a different embodiment, the device can include a transceiver that communicatively connects the device to a network element, which performs the functions ascribed to the speaking rate processor and the comprehension comparator.

It should be noted that various aspects of the invention can be implemented as a program for controlling computing equipment to implement the functions described herein, or a program for enabling computing equipment to perform processes corresponding to the steps disclosed herein. This program may be provided by sorting the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram showing a solution for increasing comprehension by detecting a speaker's rate of speech, comparing the speaking rate to a listening rate, and warning the speaker to slow down when the speaking rate exceeds the listening rate.

FIG. 2 is a flow chart of a method for automatically notifying a speaker to decrease their speaking rate in accordance with an embodiment of the inventive arrangements disclosed herein.

### DETAILED DESCRIPTION OF THE INVENTION

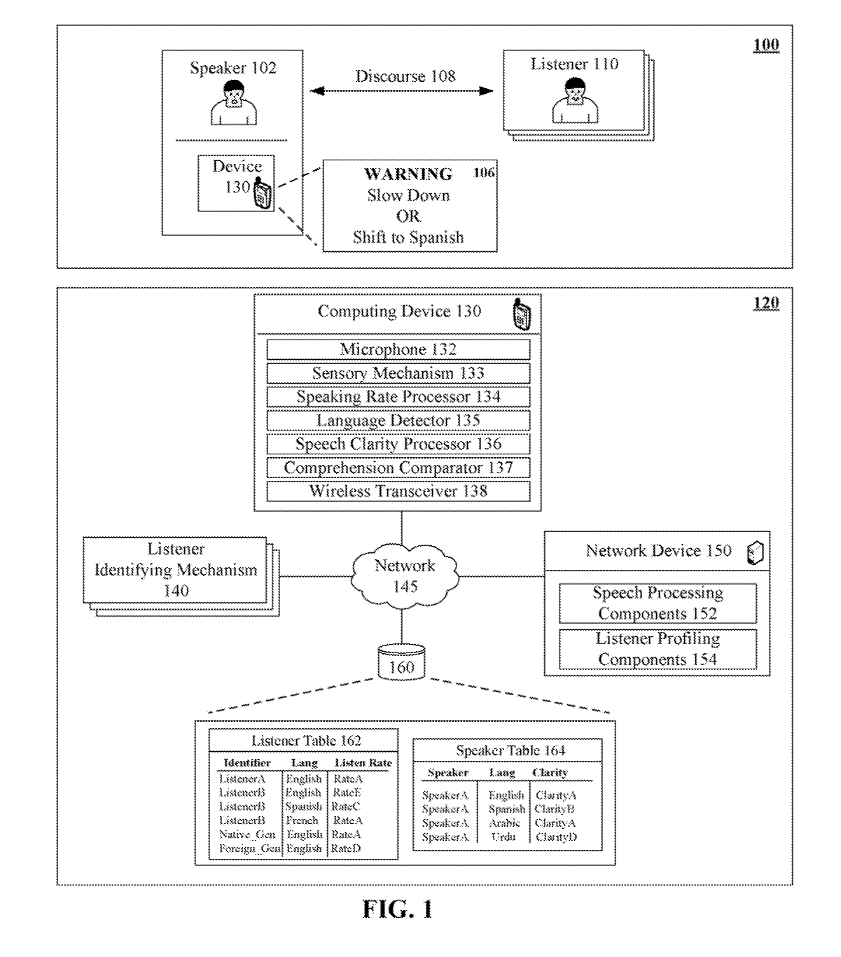

FIG. 1 is a schematic diagram showing a solution for increasing comprehension by detecting a speaker's rate of speech, comparing the speaking rate to a listening rate, and warning the speaker to slow down when the speaking rate exceeds the listening rate. System 100 shows a speaker 102 engaged in a discourse 108 with one or more listeners 110. A device 130 can monitor the rate of speech during the discourse 108. When the rate of speech is too rapid for listener 110 comprehension, an indicator 106 warning the speaker 102 to slow down can be provided.

In one embodiment, the discourse 108 can be in a language other than a primary language of listener 110. The listener 110 may be able to comprehend the spoken language, but not at a rate which a native speaker could understand it. A number of techniques can be used to automatically determine that a current language is not a primary language of the listener 110.

Further, various ones of the techniques may detect that an alternative language to that the discourse 108 language exists, which both the speaker 102 and the listener 110 are proficient in. When this is the case, the indicator 106 can include an option to shift the discourse 108 to the alternative language.

The discourse 108 can include any conversation involving the speaker 102 and the listener 110. The discourse 108 can include a face-to-face conversation, a telephone conversation, a Web-based interaction having a voice modality, a speaking engagement involving a group of attendees (listeners 110) and the speaker 102, and other communications.

In situations where a voice communication occurs using telephony devices that are linked via a network, a quality of the voice network connection can also be an important factor in determining a listener's 110 ability to comprehend the discourse 108. To account for network clarity, the device 130 can monitor a quality of a voice connection during a call and can prompt 106 the speaker 102 to decrease his or her speaking rate to a rate more comprehensible to listener 110, considering an overall quality, nature, and language of received speech.

The device 130 can be a wearable device, such as a smart phone, which can vibrate, blink, produce speech, and/or provide another indicator 106 that notifies speaker 102 to decease a speaking rate or to adjust a speaking language. In such an embodiment, the device 130 can be operable during mobile telephony calls where the listener 110 is a call participant as well as when no calls are being made where the listener 110 is a bystander. Thus, device 130 can add an entirely new function to a mobile telephone or other portable device, which is able to leverage computing capabilities of the portable device to provide this new speaking rate detection and notification ability.

The device 130 can also be integrated into a teleprompter or other mechanism or set of mechanisms that are present in an environment in which speeches are routinely given. Additionally, the device 130 can be a portable device worn by the listener 110 that includes a sensory mechanism noticeable by the speaker 102, which is selectively activated to notify the speaker 102 that a current rat of speech is too rapid for the listener 110. The device 130 can be implemented as a stand-alone computing device, as a networked computing device that utilizes processing capabilities of a remotely located networked device 150, and/or as a series of communicatively linked distributed mechanisms that together cooperatively perform the operations disclosed herein.

As shown in system 120, the computing device 130 can include a microphone 132, a sensory mechanism 133, a speaking rate processor 134, a language detector 135, a speech clarity processor 136, a comprehension comparator 137, a wireless transceiver 138, and the like. The microphone 132 can be any device that converts acoustic sound waves into an electrical representation. Microphone 132 can be used to capture the speech of speaker 102 and listener 110 to determine a language being spoken, a speaking rate, and/or a language proficiency level.

Sensory mechanism 133 can be any mechanism for informing speaker 102 that his/her speaking rate should be decreased. For example, a vibration, a tone, a flashing LED, a displayed message, a speech message, a haptic or tactile indicator, and the like can be indications provided by mechanism 133. In an embodiment having multiple sensory mechanisms 133 available, an active mechanism can be user configurable.

The speaking rate processor 134 can be used to process speech of the speaker 102 and to dynamically determine a speaking rate. The language detector 135 can process speech to determine a language being spoken. The comprehension comparator 137 can compare a speaking rate against a speaking rate threshold and can trigger mechanisms 133 to indicate a speaker 102 needs to slow down, when appropriate.

The speech clarity processor 136 can analyze speech to determine a clarity value, which can be used to adjust a speaking rate and/or a speaking rate threshold. The clarity value can be based upon a clarity with which a communicating party 102 speaks and also based on a quality of a voice network connection, if any is present, over which speech is conveyed to a listener 110.

In one contemplated implementation, a speaker table 164 can be constructed and stored in a memory accessible by device 130. The speaking table 164 can enumerate languages spoken by a speaker 102 and can relate a clarity value to each spoken language. The information about speaker languages contained in table 164 can be useful in embodiments that suggest an alternative language, such as Spanish, as shown in indicator 106, which is shared by both the speaker 102 and the listener 110.

Wireless transceiver 138 can be used to exchange digital content between device 130 and one or more eternal systems communicatively linked to the network 145. For example, wireless transceiver 138 can be used to exchange digital content between computing device 130 and network device 150. Network device 150 can include speech processing components 152 configured to perform one or more of the operations associated with processor 134, detector 135, processor 136, and/or comparator 137. Remote speech processing by components 152 can be particularly advantageous in situations where device 130 is a resource constrained device that is unable to locally perform speech processing operations.

Device 150 can also include one or more listener profiling and/or identification components 154. In one embodiment, the listener profiling components 154 can cooperatively interact with listener identifying mechanisms 140. For example, mechanism 140 can be a Radio Frequency Identification (RFID) tag worn by a listener, which is readable by components 154. The tag can provide a listener identification that can be a key value of listener table 162, which can relate to listener languages and listening rates. The listening rates can correspond to a language proficiency and can be used to establish a listener-specific speaking rate threshold. Listening rate thresholds and additional information can also be directly stored upon the RFID tag, worn by the listener 110.

In another embodiment, the listener profiling components 154 can use speech analysis, video analysis, and other technologies to identify the listener 110, so that table 162 values can be utilized. In yet another embodiment, the listener profiling components 154 can be configured to determine characteristics of a listener 110, as opposed to actual listener identity, which are indicative of a language proficiency. For example, components 154 can determine a speaking rate of the listener in the discourse 108 language and can base the speaking rate threshold on the listener's speaking rate. In another example, listener speech can be examined for semantic and acoustic queues that are indicative of the listener's proficiency with a particular language. In still another example, a listener's appearance can be analyzed for region specific characteristics, such as Asian characteristics, Arabic characteristics, and the like, and assumptions relating to language proficiency can be made based upon these characteristics. Preferably, imprecise indicators, such as appearance based markers, can be combined with other indicators to increase an accuracy of language proficiency estimations.

As shown in system 120, network 145 can include any hardware/software/and firmware necessary to convey digital content encoded within carrier waves. Content can be contained within analog or digital signals and conveyed through data or voice channels. The network 145 can include local components and data pathways necessary for communications to be exchanged among computing device components and between integrated device components and peripheral devices. The network 145 can also include network equipment, such as routers, data lines, hubs, and intermediary servers which together form a packet-based network, such as the Internet or an intranet. The network 145 can further include circuit-based communication components and mobile communication components, such as telephony switches, modems, cellular communication towers, and the like. The network 145 can include line based and/or wireless communication pathways.

Additionally, data store 160 can be a physical or virtual storage space configured to store digital content. Data store 160 can be physically implemented within any type of hardware including, but not limited to, a magnetic disk, an optical disk, a semiconductor memory, a digitally encoded plastic memory, a holographic memory, or any other recording medium. Further, data store 160 can be a stand-alone storage unit as well as a storage unit formed from a plurality of physical devices. Additionally, content can be stored within data store 160 in a variety of manners. For example, content can be stored within a relational database structure or can be stored within one or more files of a file storage system, where each file may or may not be indexed for information searching purposes. Further, data store 160 can optionally utilize one or more encryption mechanisms to protect stored content from unauthorized access.

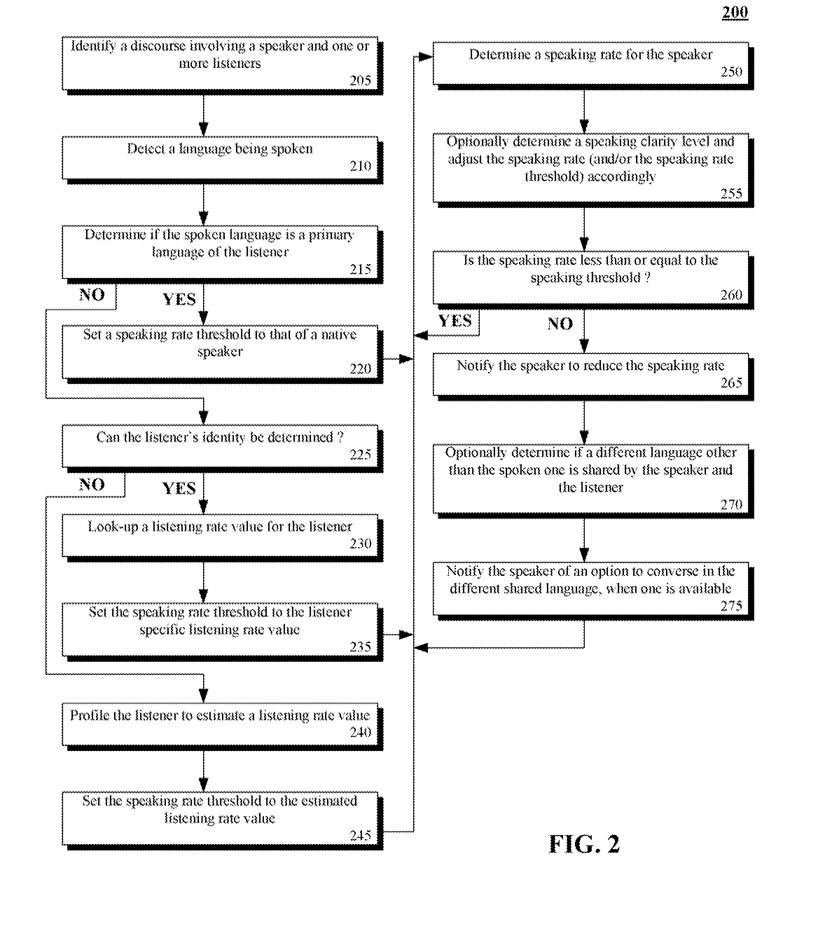

FIG. 2 is a flow chart of a method 200 for automatically notifying a speaker to decrease their speaking rate in accordance with an embodiment of the inventive arrangements disclosed herein. The method 200 can be performed in the context of system 120.

Method 200 can begin in step 205, where a discourse involving a speaker and one or more listeners can be identified. In step 210, a language being spoken can be detected. In step 215, a determination can be made regarding whether the spoken language is a primary language of the listener. If so, the method can progress from step 215 to step 220, where a speaking threshold can be set to that of a native speaker. The method can then skip from step 220 to step 250.

When the spoken language is not a primary language of the listener, the method can progress from step 215 to step 225, where an attempt can be made to determine the listener's identity. If the attempt of step 225 is successful, step 230 can be performed, where a listening rate associated with the listener can be determined. In step 235, a speaking rate threshold can be set to the listener specific rate. The method can skip from step 235 to step 250.

When in step 225, a listener identify cannot be determined, the method can progress to step 240, where the listener can be profiled to estimate a listening rate. For example, speech processing of listener provided speech can be performed to detect whether the listener has a heavy accent, which can be indicative of the listener not being a native speaker of that language. In step 245, the speaking rate threshold can be set to the estimated listening rate.

In step 250, a speaking rate for the speaker can be determined. In optional step 255, a speaking clarity value can be determined for the speaker. The speaker rate can be adjusted in accordance with the speaking clarity. That is, a faster speaking rate can be comprehensible when speech clarity is high than when speech clarity is low. In one contemplated embodiment, speaking clarity can be affected by the emotional content or emotional pitch of a discourse. Thus, one actor in determining a clarity value can be ascertained by analyzing the discourse for emotional content. Generally, discourses with high emotional content have a lower clarity level than discourses with minimal emotional content.

In step 260, a determination can be made as to whether the speaking rate is less than or equal to the speaking threshold. This comparison can indicate whether the listener is able to comprehend the conversation. When the speaking rate does not exceed the threshold, the method can loop from step 260 back to step 250, where a speaking rate for the speaker can again be determined. The loop can continue for a duration of a discourse.

When the speaking rate exceeds the speaking threshold, the method can progress from step 260 to step 265, where the speaker can be notified to reduce their speaking rate. In optional step 270, a determination can be made as to whether the speaker and listener share a language other than the language being spoken. For example, the speaker, who was originally speaking in English, can also speak Spanish, which can be a primary language of the listener. Moreover, the speaker's proficiency with Spanish can be greater than the listener's proficiency with English, which would make changing the language of the discourse beneficial from an overall comprehension standpoint. In step 275, the speaker can be notified of the shared alternative language, and be thereby provided an option to shift the conversation language to the alternative language. When a language change occurs, different values for the speaking rate threshold and speaker clarity can be determined (not shown). The method can loop from step 275 to step 250, where a speaking rate of the speaker can continue to be determined.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the compute system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. An automated method to facilitate understanding between discourse participants comprising:
automatically ascertaining a speaking rate threshold for a listener, wherein the speaking rate threshold is a threshold over which the listener is likely to have difficulty comprehending speech;
automatically determining a speaking rate of a speaker, who is speaking to the listener; and
automatically notifying the speaker that the speaking rate of the speaker should be decreased whenever the speaking rate exceeds the speaking rate threshold.

2. The method of claim 1, further comprising:
providing a mobile computing device comprising a microphone and an indicator;
receiving speech from the speaker via the microphone, wherein the speaking rate is determined from the received speech; and
performing the step of notifying the speaker using the indicator.

3. The method of claim 2, wherein the mobile computing device is a mobile telephone.

4. The method of claim 2, wherein the computing device includes a wireless transceiver configured to send and receive digital content to and from at least one remotely located network device, wherein the ascertaining step and the determining step are performed by the network device.

5. The method of claim 1, further comprising:
automatically determining a listening rate for the listener, wherein listening rates are variable for different listeners; and
dynamically setting a value for the speaking rate threshold based on the listening rate of the listener.

6. The method of claim 5, further comprising:
determining an identity of the listener; and
searching a memory containing an organized collection of information to ascertain the determined listening rate based upon the determined identify, wherein the organized collection of information associates a plurality of identities with a plurality of related listening rates.

7. The method of claim 1, further comprising:
determining a language being spoken by the speaker;
ascertaining a listener's proficiency with the language; and
establishing the speaking rate threshold based upon this proficiency.

8. The method of claim 7, further comprising:
ascertaining an alternative language to the determined language, where the alternative language is shared by both the speaker and the listener; and
automatically notifying the speaker that both the speaker and the listener are able to converse in the alternative language.

9. The method of claim 1, further comprising:
determining a clarity value for speech of the speaker; and
automatically adjusting at least one of the speaking rate and the speaking rate threshold based upon the clarity value.

10. The method of claim 1, wherein said steps of claim 1 are steps performed by at least one machine in accordance with at least one computer program stored within a machine readable memory, said computer program having a plurality of code sections that are executable by the at least one machine.

11. A method for facilitating comprehension during a discourse based in part upon a discourse language comprising:
detecting a situation wherein a speaker is engaged in a discourse including a listener;
determining a language of the discourse;
ascertaining a listener's proficiency with the language and establishing a speaking rate threshold based upon this proficiency;
determining a speaking rate of the speaker; and
when the speaking rate exceeds the speaking rate threshold, automatically notifying the speaker to decrease the speaking rate.

12. The method of claim 11, further comprising:
determining a clarity value for speech of the speaker; and
automatically adjusting at least one of the speaking rate and the speaking rate threshold based upon the clarity value.

13. The method of claim 11, further comprising:
ascertaining an alternative language to the determined language, where the alternative language is shared by both the speaker and the listener; and
automatically notifying the speaker that both the speaker and the listener are able to converse in the alternative language.

14. The method of claim 11, wherein said steps of claim 11 are steps performed by at least one machine in accordance with at least one computer program stored within a machine readable memory, said computer program having a plurality of code sections that are executable by the at least one machine.

15. A device for facilitating understanding between discourse participants comprising:
a microphone configured to receive speech of a speaker; and
a sensory mechanism configured to automatically inform the speaker when that speaker's rate of speech is too rapid for a listener to easily comprehend spoken dialog, wherein a determination that the speaking rate is too rapid is based upon automatically comparing the speaking rate of the speaker against a previously established speaking rate threshold.

16. The device of claim 15, further comprising:
a speaking rate processor configured to determine the speaking rate for the received speech obtained via the microphone; and
a comprehension comparator configured to compare the determined speaking rate against the speaking rate threshold.

17. The device of claim 16, further comprising:
a language detector configured to determine a language being spoken by the speaker, wherein the speaking rate threshold is based at least in part upon a proficiency that the listener has with the language.

18. The device of claim 15, further comprising:
a wireless transceiver configured to send and receive digital content to and from at least one remotely located network device, wherein said network device receives speech from the wearable device, determines the speaking rate of the received speech, compares the speaking rate against the previously established speaking rate threshold, and conveys a notification to the wearable device when the speaking rate exceeds the threshold, wherein the indicator automatically informs the speaker that the speaker's rate of speech is too rapid in response to receiving the notification.

19. The device of claim 16, further comprising:
a listener identifying mechanism configured to automatically determine an identity of the listener; and
a memory containing an organized collection of information in which listener profiles are stored, wherein the organized collection of information associates a plurality of listener identifies with a plurality of related listening rates, and wherein the speaking rate threshold is set to a value based upon a listening rate corresponding to the determined identify of the listener.

20. The device of claim 16, wherein the device is at least one of a teleprompter, a wearable computing device, and a mobile telephony device.
